(19) United States
(12) Patent Application Publication
(10) Pub. No.: US 2014/0035280 A1
(43) Pub. Date: Feb. 6, 2014

(54) COUPLER WITH BONDING SURFACE

(71) Applicant: Ajay Shand, Bangalore (IN)

(72) Inventor: Ajay Shand, Bangalore (IN)

(21) Appl. No.: 13/982,129

(22) PCT Filed: Dec. 29, 2011
(86) PCT No.: PCT/IN2011/000906

§ 371 Date: Oct. 14, 2013

(30) Foreign Application Priority Data
Dec. 29, 2010 (IN) 4005/CHE/2010

(51) Int. Cl. F16L 13/10

(52) U.S. Cl. CPC F16L 13/103
USPC 285/291.1

(57) ABSTRACT

The present subject matter relates to a coupler (106) for a pipe system. The coupler (106) has a first end (108) to receive one end (136) of a fixed pipe (102) and a second end (110) to receive one end of a removable pipe (104). The first end (108) is provided with first internal threads (116) corresponding to first external threads (118) on the one end (136) of the fixed pipe (102). Further, the second end (110) is provided with second internal threads (114) corresponding to second external threads (120) on the one end of the removable pipe (104). The coupler (106) has a coupler bonding surface (122) on an internal surface between a central region (138) of the coupler (106) and the first internal threads (116) of the first end (108). The coupler bonding surface (122) corresponds to a fixed pipe bonding surface (126) of the fixed pipe (102).

### TECHNICAL FIELD

The present subject matter relates in general, to pipe systems and, particularly but not exclusively, to a coupler of the pipe system.

### BACKGROUND

Pipe systems typically transport fluids from one point to another. In underground applications, such as bore wells, the pipe systems extend from above the surface of the earth to several meters below the surface. Generally, in these underground pipe systems, a large capacity motor is used to draw water from the point of origin to a further point of interest.

Generally, the underground pipe systems are lengthy and drilled deep below the surface of the earth. In such cases, a simple method of assembly is adopted by utilizing short pipe sections that are coupled together using couplers. Each of the pipe sections has threaded portions on both sides and the coupler also includes threads, which correspond to the threads on the pipe section, by which the pipe section and the coupler are connected together. Water carrying pipes used in the pipe systems are typically made of Polyvinyl chloride (PVC), which renders the pipes corrosion-free and durable.

### SUMMARY

The subject matter disclosed herein describes a coupler of a pipe system. In one embodiment, the coupler is provided with a first end to receive one end of a fixed pipe. The first end is provided with first internal threads corresponding to first external threads provided on the one end of the fixed pipe. Further, the coupler is provided with a second end to receive one end of a removable pipe, where the second end is provided with second internal threads corresponding to second external threads on the one end of the removable pipe. Moreover, the coupler is provided with a coupler bonding surface provided on an internal surface of the coupler between a central region of the coupler and the first internal threads of the first end. The coupler bonding surface corresponds to a fixed pipe bonding surface of the fixed pipe.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 illustrates a sectional view of a pipe-coupler unit in a disassembled state, the coupler having a bonding surface, in accordance with an embodiment of the present subject matter.

FIG. 2 illustrates a sectional view of a pipe-coupler unit in an assembled state, having a bonded joint, in accordance with an embodiment of the present subject matter.

FIG. 2a illustrates an enlarged view of the bonded joint, in accordance with an embodiment of the present subject matter.

### DETAILED DESCRIPTION

Pipe systems are assembled by coupling a plurality of pipe sections with a plurality of couplers. The pipe sections and the couplers are usually threaded to facilitate fastening and dismantling of the pipe system by screwing. This task of coupling individual pipe sections through couplers, however, can prove to be time consuming and tedious in the field. Therefore, to simplify operations, a single pipe section is fixedly coupled with a single coupler to form a pipe-coupler unit and, subsequently, a plurality of such pipe-coupler units are coupled together to form the pipe system. Joints in the pipe system, such as pipe and coupler joints in the pipe-coupler unit, are critical load bearing joints and are indicative of the health of the pipe system. In a pipe system, the strength of the joint between the pipe and the coupler in the pipe-coupler unit is critical for maintaining the integrity of the pipe system.

Generally, to provide a firm joint between the pipe and coupler, a locking mechanism, in addition to the threaded coupling, is provided in the pipe-coupler unit. The locking mechanism fixedly couples the coupler to one end of a pipe section. The locking mechanism may be a wire lock element accommodated in a circular groove that is partially present in the pipe and partially present in the coupler. The wire lock element locks one end of the coupler with the pipe section to provide a fixed or non-removable joint. The other end of the coupler may engage another pipe in a removable manner. However, in order to provide the circular groove, the number of threads in the coupler may need to be reduced at the end where the circular groove is to be provided. As a result, due to an unequal number of threads on both ends of the coupler, a structural imbalance of forces under loading may be introduced. In certain cases, the length of the coupler can be increased so as to maintain the same number of threads in the coupler on both the ends. However, the quantity of material required to manufacture the coupler will increase, resulting in a substantial increase in infrastructure borne costs. In an example, under heaving loading, stress concentration points can be formed around the circular grooves provided in the coupler and the pipe section. This can result in loss in strength of the pipe system and can even lead to a collapse of the pipe system over a period of time if the stress is unchecked.

Furthermore, during de-coupling of the pipe-coupler unit, for example, during a maintenance procedure, it is possible that the fixed joint of the pipe-coupler unit is accidentally undone. This may result in the integrity of the pipe system being compromised and may further lead to a collapse of the pipe system.

The present subject matter relates to a coupler of a pipe system. In one embodiment, the coupler has a first and a second end. The coupler may be provided with first and second internal threads on the first end and the second end, respectively. In an example, a fixed pipe is provided with first external threads on its ends for connecting with the coupler via the first end of the coupler. The first external threads of the fixed pipe mesh with the first internal threads of the coupler and facilitate the coupling of the fixed pipe with the coupler. In an embodiment, the fixed pipe coupled with the coupler is referred to as a pipe-coupler unit.

In an embodiment, the fixed pipe is fitted to the coupler in a non removable manner. Furthermore, the coupler is provided with a coupler bonding surface adjacent to the first internal threads of the coupler. In an embodiment, a corresponding bonding surface is provided on the fixed pipe, such that the fixed pipe bonding surface overlaps with the coupler bonding surface in the assembled state of the fixed pipe and the coupler, i.e., when the fixed pipe is screwed into the first end of the coupler. Further, an adhesive, for example, solvent cement, is provided on the coupler bonding surface, such that the fixed pipe bonding surface binds with the coupler bonding surface to form a bonded joint. The adhesive is applied on the coupler bonding surface before joining the fixed pipe with the coupler, so as to prevent the adhesive from spreading into the threads. Thus, when the fixed pipe is screwed into the coupler, the fixed pipe bonding surface comes in contact with the adhesive applied on the coupler bonding surface and binds with the coupler bonding surface, forming the bonded joint.

In addition, a removable pipe may be coupled to the second end of the coupler. Furthermore, the removable pipe may be joined to the second end of the coupler by means of threads. In an example, the removable pipe may be a fixed pipe of a subsequent pipe-coupler unit. In this manner, a plurality of the pipe-coupler units may be coupled together to form the pipe system.

The threaded portion of the fixed pipe may be coupled to an equally threaded fixed pipe end of the coupler, and a bonded joint is formed therein due to the presence of the adhesive in the coupler. This bonded joint acts as a permanent joint such that it is not un-coupled or unthreaded during the dismantling of the pipe-coupler unit.

Applying the adhesive for binding the fixed pipe with the coupler assists in facilitating a substantially strong joint capable of arresting any movement of the fixed pipe inside the coupler. During disassembly of the pipe-coupler unit, the bonded joint prevents accidental de-coupling of the fixed pipe and the coupler. Further, providing the bonded joint increases the load bearing capacity of the pipe-coupler unit.

In an embodiment, the fixed pipe bonding surface may be provided with a taper. In an example, the taper is provided by reducing an outer diameter of the fixed pipe towards a peripheral edge of the one end of the fixed pipe. According to said embodiment, the coupler bonding surface may be provided with a taper corresponding to the taper of the fixed pipe bonding surface. In an example, the taper of the coupler bonding surface may be provided by reducing an inner diameter of the coupler towards a region away from the first end of the coupler.

In an embodiment, the adhesive used to couple the fixed pipe to the coupler may be solvent cement or any cement or adhesive, which is used to fasten two PVC pipes.

These and other aspects of the present subject matter are described in greater detail in conjunction with the figures.

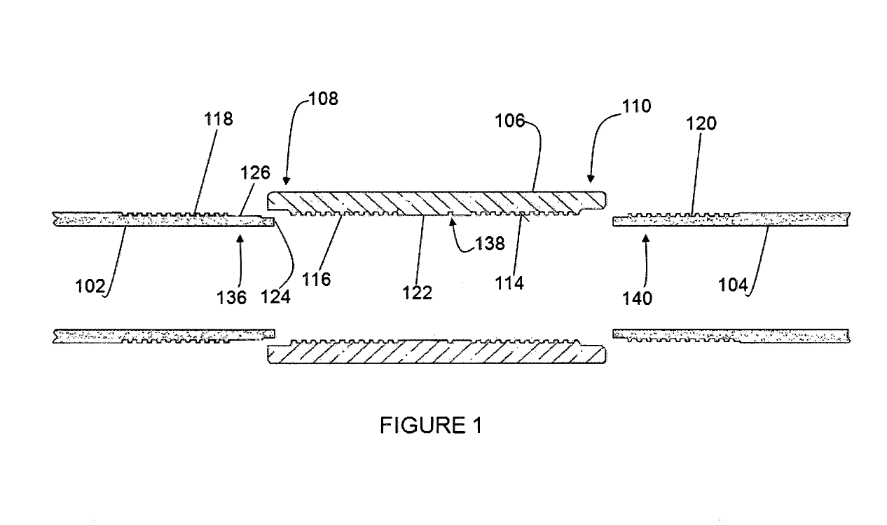

FIG. 1 illustrates a sectional view of a coupler 106 of a pipe-coupler unit 100 in a disassembled state, the coupler 106 having a coupler bonding surface 122 in accordance with an embodiment of the present subject matter.

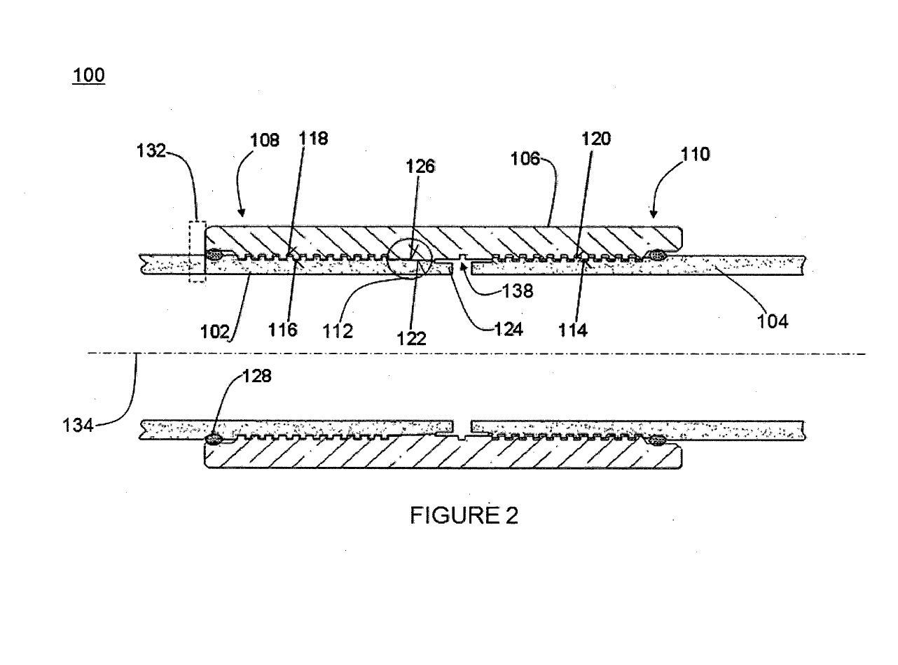

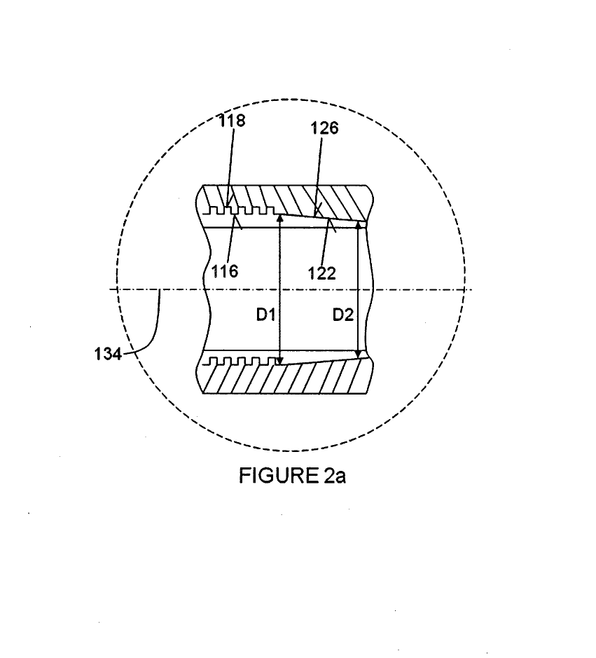

In an embodiment, the coupler 106 has two ends, namely a first end 108, to receive a fixed pipe 102, and a second end 110, to which a removable pipe 104 may be joined. Furthermore, the coupler 106 has a central region 138. In an example, the central region 138 is located internally at a midpoint of a length of the coupler 106. The length of the coupler 106 may be measured along a longitudinal axis (shown in FIG. 2) of the coupler 106, from a peripheral edge of the first end 108, to a peripheral edge of the second end 110.

In one embodiment, the first end 108 of the coupler 106 is provided with first internal threads 116 disposed on an inner surface of the coupler 106. Further, corresponding first external threads 118 are provided on an outer surface of one end 136 of the fixed pipe 102. The first external threads 118 of the fixed pipe 102 are provided such that they may mesh with the first internal threads 116 in the coupler 106 to join the fixed pipe 102 with the coupler 106. Furthermore, the second end 110 of the coupler 106 is provided with second internal threads 114 disposed on the inner surface of the coupler 106. Correspondingly, second external threads 120 are provided on an outer surface of one end 140 of the removable pipe 104, such that the second external threads 120 may mesh with the second internal threads 114, to join the removable pipe 104 with the coupler 106. In an implementation, the first internal threads 116, the first external threads 118, the second internal threads 114 and the second external threads 120 may be provided with a square thread profile, or with a triangular thread profile, or with a trapezoidal thread profile. In an implementation, the first internal threads 116 and the second internal threads 114 are equal in number to the first external threads 118 and the second external threads 120, respectively. Such a configuration of the threads provides symmetry to the pipe-coupler unit 100 and imparts equal load distribution.

In one embodiment, the coupler 106 is provided with a coupler bonding surface 122. In an embodiment, the coupler bonding surface 122 is provided on an internal surface of the coupler 106, between the first internal threads 116 and the central region 138 of the coupler 106, such that the first internal threads 116 extend up to the coupler bonding surface 122, as shown in FIG. 1. Furthermore, in an embodiment, a fixed pipe bonding surface 126 is provided on an external surface of the fixed pipe 102, between a peripheral edge 124 of the coupler end 136 of the fixed pipe 102 and the first external threads 118, as shown in FIG. 1. The coupler bonding surface 122 and the fixed pipe bonding surface 126 are provided such that the fixed pipe bonding surface 126 overlaps with the coupler bonding surface 122 when the fixed pipe 102 is coupled with the coupler 106. In one implementation, a width of the fixed pipe bonding surface 126 is equal to a width of the coupler bonding surface 122. In an example, the fixed pipe bonding surface 126 and the coupler bonding surface 122 have a width between about 10 mm and 25 mm. Furthermore, the width of the fixed pipe bonding surface 126, and the coupler bonding surface 122 is measured along a longitudinal axis 134 (shown in FIG. 2) of the pipe-coupler unit 100.

The fixed pipe 102 and the coupler 106 may be made of polyvinyl chloride (PVC) material that is lightweight and has non-corrosive properties.

FIG. 2 illustrates a sectional view of the pipe-coupler unit 100 in an assembled state, having a bonded joint 112, in accordance with an embodiment of the present subject matter.

In an embodiment, the pipe-coupler unit 100 includes the fixed pipe 102 and the coupler 106. As mentioned earlier, the pipe-coupler unit 100 is formed by screwing the fixed pipe 102 into the coupler 106 via the first end 108 of the coupler 106.

In one embodiment, an adhesive, such as solvent cement, is applied on the coupler bonding surface 122 prior to the assembly of the pipe-coupler unit 100, such that the fixed pipe bonding surface 126 binds with the coupler bonding surface 122 to form a joint, also referred to as the bonded joint 112, as shown in FIG. 2. In an example, in case the adhesive is a solvent cement, the solvent cement can include a solvent and a polymer resin that is also used in the manufacture of the pipe systems. In an example, the solvent can be a volatile compound capable of dissolving polymer compounds, such as PVC. The adhesive is generally formulated to facilitate pipe systems to withstand operational pressures and vibrations. According to the present subject matter, prior application of the adhesive on .the coupler bonding surface 122 prevents the adhesive from spreading onto the first internal threads 116 and the first external threads 118. In an implementation, the pipe-coupler unit 100 may be constructed in two phases. In the first phase, the fixed pipe 102 is fixedly joined with the coupler 106, and in the second phase, the removable pipe 104 may be coupled with the coupler 106.

In the first phase, initially, a primer may be used to clean and pre-soften the coupler bonding surface 122 and the fixed pipe bonding surface 126. The adhesive is then applied on the coupler bonding surface 122 and is allowed to set on the coupler bonding surface 122. The time taken for the adhesive to set on the coupler bonding surface 122 may vary, depending on room temperature and dimensions of the fixed pipe 102. In an implementation, when the adhesive used is solvent cement, the solvent in the solvent cement dissolves the surface of the coupler bonding surface 122 by penetrating an inner diameter of the coupler. In an example, the grade of adhesive can be selected depending on an ambient temperature. The range of temperature of operation of the adhesive generally varies between a range of about −30° C. to about 45° C. In another example, depending on the environmental laws of a region, volatile organic compound (VOC) solvent cements may be used as adhesives. VOC solvent cements are specially formulated to meet VOC emission requirements in certain jurisdictions.

In an example, the time taken for the adhesive to set on the coupler bonding surface 122 may be less than about two minutes from the time the adhesive is applied on the coupler bonding surface 122. Certain adhesives are of a fast setting type, for example, suited for wet conditions.

Once the adhesive is applied on the coupler bonding surface 122, the fixed pipe 102 is screwed into the first end 108 of the coupler 106 such that the first external threads 118 of the fixed pipe 102 mesh with the first internal threads 116 of the coupler 106, and subsequently the fixed pipe bonding surface 126 aligns with the coupler bonding surface 122. In another example, the fixed pipe 102 may be screwed into the first end 108 of the coupler 106 immediately after the adhesive is applied on the coupler bonding surface 122.

In an implementation, the adhesive can be applied on the coupler bonding surface 122 to soften the coupler bonding surface 122. Furthermore, when the fixed pipe bonding surface 126 comes in contact with the coupler bonding surface 122, due to a reactive action of the adhesive, the polymer resin in the adhesive then intermeshes the coupler bonding surface 122 and the fixed pipe bonding surface 126. Simultaneously, the solvent in the adhesive may continue to soften and dissolve the materials of the coupler bonding surface 122 and the fixed pipe bonding surface 126. Furthermore, due to an interference fit between the coupler bonding surface 122 and the fixed pipe bonding surface 126, the softened surfaces weld together to form the bonded joint 112.

In an implementation, the bonded joint 112 can then be held stable and external pressure can be applied to facilitate the formation of a strong joint. In addition, to strengthen the bonded joint 112, the bonded joint 112 can be taken through a process of curing. Curing refers to a process by which toughening or hardening of a polymer material is brought about by chemical additives. In an example, during the curing process, the solvent in the adhesive evaporates until a proper handling strength is imparted to the joint formed therein, and ultimately leading to a fully cured bonded joint 112. The time taken by the adhesive to bind the fixed pipe bonding surface 126 with the coupler bonding surface 122, referred to as curing time, may vary, depending on the size of the fixed pipe 102, adhesive type, amount of adhesive applied, humidity, wind velocity, and the ambient temperature. For example, a fixed pipe of larger diameter will cure at slower rates as compared to a fixed pipe of smaller diameter. Adhesives formulated for faster set times will have smaller cure times as compared to adhesives formulated for slower set times. Furthermore, over-application of adhesive will cause a much slower curing time as the volume of solvent is greater, thus taking longer to evaporate. Further, the higher the humidity, the slower the curing time due to excess atmospheric moisture that retards rate of evaporation of the solvent in the adhesive. When adhesive is applied in areas of wind velocity of over 10 mph, faster curing times are provided due to escalated rates of evaporation. Moreover, the higher the ambient temperature, the faster the cure. Based on aforesaid conditions, the curing time may be in a range between about 20 and 30 hours to impart handling strength to the bonded joint 112. Once the bonded joint 112 is properly cured, the pipe system may undergo pressure testing to test the strength of the bonded joint 112.

Table 1 provided below illustrates examples of curing time for different pipe diameters as well as temperature ranges. The relative humidity in the following illustration is maintained at approximately 60% or less, and the standard pressure testing occurs at two stages, i.e., up to 180 psi and above 180 psi of pressure. The following values are provided for illustrational purposes only and should not be construed as a limitation as field conditions may vary.

TABLE 1

| Relative | Pipe | | Pipe | | Pipe | | Pipe | | | |
|---|---|---|---|---|---|---|---|---|---|---|
| Humidity | Diameter | | Diameter | | Diameter | | Diameter | | Pipe | Pipe |
| 60% or less | ½″ to 1¼″ | | 1½″ to 3″ | | 4″ to 5″ | | 6″ to 8″ | | Diameter | Diameter |
| Temp during | Up to | | Up to | | Up to | | Up to | | 10″ to 16″ | 18″+ |
| cure period | 180 psi | 180 psi + | 180 psi | 180 psi + | 180 psi | 180 psi + | 180 psi | 180 psi + | Up to 100 psi | Up to 100 psi |
| 16° C.-38° C. | 1 hrs | 6 hrs | 2 hrs | 12 hrs | 6 hrs | 18 hrs | 8 hrs | 24 hrs | 24 hrs | 36 hrs |
| 4° C.-16° C. | 2 hrs | 12 hrs | 4 hrs | 24 hrs | 12 hrs | 36 hrs | 16 hrs | 48 hrs | 48 hrs | 72 hrs |
| −7° C.-4° C. | 6 hrs | 36 hrs | 12 hrs | 72 hrs | 36 hrs | 4 days | 3 days | 9 days | 8 days | 12 days |
| −18° C.-−7° C. | 8 hrs | 48 hrs | 16 hrs | 96 hrs | 48 hrs | 8 days | 4 days | 12 | days10 days | 14 days |

The adhesive assists in facilitating a strong bonded joint 112 for binding the fixed pipe 102 with the coupler 106. This bonded joint 112 is capable of arresting the movement of the fixed pipe 102 inside the coupler 106, and is therefore beneficial during the disassembly of the pipe-coupler unit 100. Moreover, the bonded joint 112 provides additional load bearing capacity of the pipe-coupler unit 100.

In one embodiment, the coupler bonding surface 122 may be provided with an uneven surface or a friction surface, for example, by providing substantially fine grooves. The uneven surface facilitates the binding between the coupler bonding surface 122 and the fixed pipe bonding surface 126.

In another embodiment, the coupler bonding surface 122 is provided with a tapering surface narrowing towards a central longitudinal axis 134 of the pipe-coupler unit 100. In said embodiment, the taper of the coupler bonding surface 122 may be provided by reducing an inner diameter of the coupler 106 towards a region away from the first end 108 of the coupler 106.

Further, in said embodiment, the fixed pipe bonding surface 126 is configured with a taper, narrowing towards the central longitudinal axis 134 of the pipe-coupler unit 100, corresponding to the taper of the coupler bonding surface 122. Such tapered configurations of the coupler bonding surface 122 and the fixed pipe bonding surface 126 ensures efficient fitting and alignment of the fixed pipe bonding surface 126 with the coupler bonding surface 122.

In the second phase of construction of the pipe coupler unit 100, the removable pipe 104 may be coupled with the second end 110 of the coupler 106 via the second internal threads 114 of the coupler 106 and second external threads 120 of the removable pipe 104. The removable pipe 104 is joined at the second end 110 of the coupler 106 such that the second external threads 120 of the removable pipe 104 mesh with the second internal threads 114 of the coupler 106 to form a removable joint. The removable joint enables dismantling of removable pipe 104 and the coupler 106. In an implementation, the removable pipe 104 may be a fixed pipe of a subsequent pipe-coupler unit 100. As described earlier, by coupling a plurality of these pipe-coupler units 100, the pipe system may be constructed.

In addition, coupling of both the fixed pipe 102 and the removable pipe 104 with the coupler 106 may be made leak proof by providing a sealing ring 128. In one embodiment, the sealing ring 128 is provided to serve as an additional safeguard to prevent leakage of fluid from the fixed pipe 102 and penetration of fluid into the pipe-coupler unit 100. In said embodiment, the sealing ring 128 is disposed in a groove provided on the external surface of the fixed pipe 102. Further, a groove can also be provided in the internal surface of the coupler to receive the sealing ring 128. Therefore, the sealing ring 128 is disposed between the internal surface of the coupler 106 and the external surface of the fixed pipe 102. In one implementation, the sealing ring 128 may be an O-ring.

Further, in an embodiment, a visible indication mechanism 132 may also be provided on the fixed pipe 102 adjacent to the first end 108 of the coupler 106 to provide an indication of an opening of the bonded joint 112 between the fixed pipe 102 and the coupler 106, for example, in case of an accident. In one example, the visible indication mechanism 132 may be a wire lock. The visible indication mechanism 132 provides a simple visible aid in case of the opening of the bonded joint 112 of the fixed pipe 102 and the coupler 106 during assembly and disassembly of the pipe system.

FIG. 2a illustrates an enlarged view of the bonded joint 112, in accordance with one embodiment of the present subject matter.

In an embodiment, the taper of the coupler bonding surface 122 and the taper of the fixed pipe bonding surface 126 are provided such that the respective tapers narrow toward the central longitudinal axis 134 as described previously.

As shown in the figure, the taper of the coupler bonding surface 122 and the taper of the fixed pipe bonding surface 126 are provided such that a first outer diameter D1 of the fixed pipe 102 measured adjacent to the first external threads 118 of the fixed pipe 102 is greater than a second outer diameter D2 of the fixed pipe 102 adjacent to the peripheral edge 124 of the fixed pipe 102.

Although the subject matter has been described in considerable detail with reference to certain embodiments thereof, other embodiments are possible. It is to be understood that the appended claims are not necessarily limited to the features described herein. Rather, the features are disclosed as embodiments of the coupler 106 and the pipe-coupler unit 100 having the bonded joint 112.

I/we claim:

1. A coupler (106), for a pipe system, the coupler (106) being provided with:
a first end (108) to receive one end (136) of a fixed pipe (102), wherein the first end (108) is provided with first internal threads (116) corresponding to first external threads (118) on the one end (136) of the fixed pipe (102);
a second end (110) to receive one end (140) of a removable pipe (104), wherein the second end (110) is provided with second internal threads (114) corresponding to second external threads (120) on the one end (140) of the removable pipe (104); and
a coupler bonding surface (122) provided on an internal surface between a central region (138) of the coupler (106) and the first internal threads (116) of the first end (108), wherein the coupler bonding surface (122) corresponds to a fixed pipe bonding surface (126) of the fixed pipe (102).

2. The coupler (106) as claimed in claim 1, wherein the coupler bonding surface (122) is provided with an adhesive.

3. The coupler (106) as claimed in claim 1, wherein the coupler bonding surface (122) is tapered.

4. The coupler (106) as claimed in claim 1, wherein the coupler bonding surface (122) has a width between about 10 mm to about 25 mm.

5. The coupler (106) as claimed in claim 1, wherein the first internal threads (116) and the second internal threads (114) have one of a square thread profile, a triangular thread profile, and a trapezoidal thread profile.

6. A pipe-coupler unit (100) comprising:
a fixed pipe (102), one end (136) of the fixed pipe (102) being provided with first external threads (118), wherein the fixed pipe (102) is further provided with a fixed pipe bonding surface (126) on an external surface between a peripheral edge (124) of the one end (136) and the first external threads (118); and
a coupler (106) having a first end (108) coupled to the one end (136) of the fixed pipe (102), the coupler (106) having first internal threads (116) corresponding to the first external threads (118), wherein the coupler (106) is provided with a coupler bonding surface (122) on an internal surface between a central region (138) of the coupler (106) and the first internal threads (116) of the first end (108), and wherein the coupler bonding surface (122) is provided with an adhesive, to form a bonded joint (112) with the fixed pipe bonding surface (126) in an assembled state of the pipe-coupler unit (100).

7. The pipe-coupler unit (100) as claimed in claim 6, wherein the fixed pipe bonding surface (126) and the coupler bonding surface (122) is tapered.

8. The pipe-coupler unit (100) as claimed in claim 6, wherein the adhesive is a solvent cement.

9. The pipe-coupler unit (100) as claimed in claim 6, wherein the fixed pipe bonding surface (126) has a width between about 10 mm to about 25 mm.

10. The pipe-coupler unit (100) as claimed in claim 6, wherein the coupler bonding surface (122) has a width between about 10 mm to about 25 mm.

11. The pipe-coupler unit (100) as claimed in claim 6, wherein the first external threads (118) and the first internal threads (116) are equal in number.

12. The pipe-coupler unit (100) as claimed in claim 6, wherein the first external threads (118) and the first internal threads (116) each have one of a square thread profile, a triangular thread profile, and a trapezoidal thread profile.
